(19) United States
(12) Patent Application Publication
(10) Pub. No.: US 2002/0004727 A1
(43) Pub. Date: Jan. 10, 2002

(54) Broadband computer-based networked systems for control and management of medical records

(76) Inventors: William A. Knaus, Charlottesville, VA (US); Richard D. Marks, McLean, VA (US)

Correspondence Address: BROBECK, PHLEGER & HARRISON, LLP, ATTN: INTELLECTUAL PROPERTY DEPARTMENT, 1333 H STREET, N.W. SUITE 800, WASHINGTON, DC, 20005, US

(21) Appl. No.: 09/816,152

(22) Filed: Mar. 26, 2001

Related U.S. Application Data
(60) Provisional application No. 60/216,147, filed on Jul. 3, 2000.

(51) Int. Cl. G06F 17/60

(52) U.S. Cl. 705/3

(57) ABSTRACT

This invention relates to an Internet or other broadband computer-based networked system, operated by a service provider that enables members of the system provider network, which may be patients, family members, employees or others, to assemble, update, enhance, analyze, correct, broker, securely store and transmit, certify and otherwise manage the medical records and, under appropriate circumstances, the medical records of family, friends, clients or customers and integrates those medical records and their updating around the patient.

### REFERENCE TO RELATED APPLICATIONS

This application claims priority to U.S. Provisional Application No. 60/216,147, filed Jul. 3, 2000.

### BACKGROUND

1.Field of the Invention

This invention relates to computer-based networked systems, and, in particular, to methods for creating and utilizing a broadband computer-based networked system for individualized control and management of medical records. In particular, the invention relates to methods in which the creation, control and management of medical records are secure and certified as accurate, having the attribute of non-repudiation. The invention also relates to methods for the creation, storage and access of secure medical records, to databases and methods for manipulating, analyzing and securely transmitting medical records, and to business methods directed to the individualized control of medical records and the exchange of medical information.

2.Description of the Background

Many new medical records are today created electronically because, at least in part, electronic records are simpler and less expensive to create, maintain and work with as compared to traditional paper records. In fact, traditional paper records are being converted to electronic formats at an accelerated pace. In response to this electronic revolution, systems have been developed which attempt to protect the privacy of medical information while utilizing the advantages of electronic information technology.

Some of the first systems developed involved the use of personal identification cards. These cards would be electronically coded to provide an individual with secure access to certain types of information and many such cards have received patents. For example, U.S. Pat. No. 6,131,090 relates to a method and system for providing controlled access to information stored on a smartcard. The system includes a data processing center maintained by a trusted third party for storing a database of authorizations of various service providers to access information pertaining to individuals, and for responding to requests by service providers for access from terminals which communicate with the data processing center and smartcards storing the individuals' information. The information is stored on the smartcard in encrypted form and the data processing center provides an access code, which includes a key for decrypting the information, only to service providers who are authorized to access the information. The service provider then sends the access code to the smartcard, which verifies the access code and decrypts and outputs the requested information. The smartcard then computes a new key as a function of information unique to each access session and uses the new key to re-encrypt the information, and then erases the new key. The data processing center also computes the new key so that the data processing center can provide an access code including the new key for the next request for access.

U.S. Pat. No. 5,325,294 relates to a medical privacy system for providing authorized access to medical information concerning an individual. According to this system, a computer database receives and stores an individual's medical information, but does not contain a name, address or any other similar information by which that individual can be identified. The individual is given an identification card containing a photograph or holographic image of the individual and a confidential first identification number that is unique to the individual, where both the image and the first identification number are visually perceptible and cannot be altered without detection. The individual is also given a second identification number that is not contained on the card and is unique to the individual. The database can be accessed telephonically and the individual's medical information accessed after the first and second identification numbers are provided. A cryptographic module such as a smartcard is disclosed in U.S. Pat. No. 5,721,777. A computerized system that can be accessed by smartcard is disclosed in U.S. Pat. No. 5,832,488.

U.S. Pat. No. 5,465,082 relates to a distributed data processing network containing multiple memory card databases at terminal nodes of the network. The network is programmed to automatically perform routine communications operations such as conveying identification information between terminal nodes and interior nodes. This system is typically found in a single institution and generally communicates poorly if at all with other systems. U.S. Pat. No. 5,867,821 relates to a method and apparatus for distribution and administration of medical records.

U.S. Pat. No. 5,899,998 relates to a method and system for maintaining and updating computerized records in a self-updating system that employs point-of-service stations disposed at medical service locations. Each patient carries a portable data carrier such as a smart card that contains the patient's complete medical history. Interaction between the portable data carriers and the point of service stations effects a virtual communication link that ties the distributed databases together without the need for online or live data connections. The point-of-service stations are also interconnected over a communications network through a switching station that likewise does not rely on online, live communications.

Other medical information systems, not based on smartcards, have also received patents. For example, U.S. Pat. No. 5,915,240 relates to a medical lookup reference computer system for accessing medical information over a network. The system partitions the functioning of the system between a client and a server program in an optimal manner to assure synchronization of the master medical information database on the servers with the local medical information databases on the client, minimize the use of network resources, and allow new types of medical information to be easily included in the system. A server on the network maintains a description of its medical information, as well as the most up to date medical reference information. The client program maintains a local database which is automatically synchronized over the network with revisions and new medical information, and provides a user with an interface to fully review the information in the database.

U.S. Pat. No. 5,924,074 relates to a medical records system that creates and maintains all patient data electronically. The system captures patient data, such as patient complaints, lab orders, medications, diagnoses and procedures, at its source at the time of entry using a graphical interface having touch screens. The system permits instant, sophisticated analysis of patient data to identify relationships among data considered.

U.S. Pat. No. 5,930,759 relates to a system or network for assembling, filing and processing health care data transactions and insurance claims made by patients pursuant to health care policies issued to the patients by insurance companies or other carriers for services provided to the patients at health care facilities.

U.S. Patent no.5,946,659 relates to a multiple user computerized clinical care system which includes the use of a group of terminals communicating with a central computer system for sending and receiving patient information for storage and retrieval purposes. The system and method include managing patient information variance requests by storing the variance information in the order in which the variance requests are received. The terminals are then supplied with the stored variance information to enable the terminals of the computer system to receive current updated patient information for a given patient substantially concurrently as the updated information is being entered at a plurality of the terminals, without causing any user to wait for the current variance information.

U.S. Pat. No. 5,974,389 relates to a patient medical record system that includes a number of caregiver computers, and a patient record database with patient data coupled to the caregiver computers selectively providing access to the patient data from one of the caregiver computers responsive to a predetermined set of access rules. The predetermined set of rules includes a rule that access to a predetermined portion of the patient data by a first caregiver must be terminated before access to the same predetermined portion of the second caregiver is allowed.

U.S. Pat. No. 6.032,119 relates to a personalized display of health information. Delivery of information to a patient suffering from a chronic condition is personalized by displaying the health information directly on a customized image of a body. The patient's medical records, standards of care for the condition, prescribed treatments, and patient input are applied to a generalized health model of a disease to generate a personalized health model of the patient.

U.S. Pat. No. 6,073,106 relates to a method of managing and controlling access to personal information. According to this patent, via internet communication or via phone, facsimile, or mail, a participant is prompted to provide a constant identifier and a selected password. Emergency and confidential categories of medical information are identified, and the participant is prompted to provide personal information in each of the categories and a different personal identification number for each category. The person is also instructed to provide an instruction to disclose or to not disclose the personal information in the emergency category in the event a requester of the information is an emergency medical facility and is unable to provide the participant's identification number. Alteration of any of the participant's medical information is enabled upon presentation of the participant's identifier and password by the requester. The emergency information or the confidential information is disclosed upon presentation of the participant's identifier and identification number.

In response to the growth of the Internet, a few companies have arisen which claim to provide healthcare professionals with medical information over the Internet. For example, WebMD Corporation provides a service called MyHealthRecord, which it alleges enables users to organize health information online from any location via the Internet. Medscape asserts that it provides healthcare professionals and consumers with healthcare information through a service called AboutMyHealth. With this service, personal and family health information may be stored and persons can view portions of their health records. PersonalMD.com features online medical records management and an E-file, which it alleges enables users to streamline their health and medical records by maintaining them in one secure and confidential file that can be accessed via the Internet. Another, Medicalrecords.com, asserts that it enables users to store and manage medical records and provides personalized health news. HealthHero Network develops and markets a technology platform for remote patient monitoring care management and specialized research. The “Health Buddy,” which is associated with this service, is a device used by patients to respond to inquiries concerning symptoms and treatment.

Although all of these companies take advantage of the capabilities of the Internet, none provide the security necessary to compile and maintain primary records. In response to a perceived lack of guidance about the security of individual medical records, the U.S. Congress enacted the Health Insurance Portability and Accountability Act of 1996 (Y“HIPAA”). A principal purpose of HIPAA is to ensure that an individual's privacy in their own medical records is adequately maintained. HIPAA is also designed to protect the security of those records, as well as govern the way in which electronic medical information (including related payment information) is exchanged. HIPAA's privacy, security and transactions standards require that the fundamental business practices for hospitals, doctors, health plans, health clearinghouses and health insurers, and those that deal with them, be changed and pose new challenges to the entire health care industry. When final privacy regulations were promulgated by the Department of Health and Human Services in December of 2000, they created broad standards for the protection of both electronic and non-electronic medical records.

Exactly how protection under HIPAA is to be assured or even how HIPAA is to be implemented has not previously been determined. No system exists which complies with all aspects of HIPAA and none has comprehensively addressed HIPAA's requirements. Thus, a need exists for a safe, economically efficient and secure system that complies with HIPAA and its subsequent versions and replacements, and that protects the exchange of medical information so as to advance the underlying policy goals of HIPAA, the continued improvement of personal and public health care.

### SUMMARY OF THE INVENTION

The present invention is directed to an Internet or other broadband computer-based methods and apparatus that enables individuals to assemble, update, enhance, analyze, securely store and transmit, certify, and otherwise manage their individual medical records and, under appropriate circumstances, the individual medical records of their family, friends, clients and customers.

One embodiment of the invention is directed to a broadband, computer-based networked system for consumer control and management of electronic medical records. Preferably, the system complies with a federal standard of privacy and security such as, for example, the federal standards promulgated pursuant to HIPAA. The system of the invention also preferably complies with all non-federally preempted state standards of privacy and security or at least those standards that apply in the area in which the system operates. The system of the invention allows for certification of medical records and for secure access to a patient's own medical record only by said patient, users designated and authorized by said patient, or those appropriately acting for said patient. Certified medical records may achieve the attributes of non-repudiation. A preferred embodiment of this system is patient-centered in that control over a patient's medical records resides with that patient. Patient-centered medical records may be the individual patient's primary medical record and can be relied on by medical care providers in furnishing treatments, by employees in choosing from employer benefit options, and by payors in allocating payment for services.

Another embodiment of the invention is directed to methods for the creation and storage of secure electronic medical records that comply with federal standards and non-federally preempted state standards for privacy and security comprising obtaining medical records from a plurality of sources; securely inputting the records obtained into a secure computer database; allowing for only authorized users to obtain information from the database; securely transmitting information requested by authorized users to others; and securely updating the database with additional information from different sources (i.e. integration) for new or existing patients. Integration of medical information is patient-centered, not source-or physician-centered, so that the medical record created is primary for the patient and can be used and relied on for all aspects of treatment and payor compliance. The method further comprises analyzing and securely transmitting one or more, or parts of one or more, medical records, using a variety of certification standards.

Another embodiment of the invention is directed to methods for brokering a medical record of a patient comprising creating the medical record and brokering said medical record or designated portions of said record to third parties. According to these methods, the patient may have control over his or her own medical records.

Another embodiment of the invention is directed to secure databases of electronic medical records that comply with federal standards for privacy and security such as, for example, HIPAA and rules implementing HIPAA. These databases may contain portions or the entire medical history of one or more persons and be remotely accessible in whole or in part by that person or other authorized users.

Another embodiment of the invention is directed to business models comprising the creation of a secure database of medical records wherein said records may be accessed through secure transmission pathways. The database may contain all or parts of individual medical records and all or parts may be accessed and transmitted to others as directed or authorized by the individual member.

Another embodiment of the invention is directed to methods for compiling a certified medical record comprising obtaining the medical record from a member, the member's family, physicians and other care providers, and others with information to add to the database; securely inputting the record into a secure computer database; and certifying that the compiled medical record meets one of a plurality of certification standards which may be established by the service provider. Certification standards that may be used include, for example, self-certification, certification by the service provider and combinations thereof. Self-certification contains a plurality of self-certification standards that are selected by the member. Certified medical records may be securely transmitted to an authorized recipient and may be analyzed for comparing or negotiating with a plurality of health care providers and payors.

Other embodiments and advantages of the invention are set forth in part in the description which follows, and, in part, will be obvious from this description, or may be learned from the practice of the invention.

### DESCRIPTION OF THE FIGURES

FIG. 1 Member enrollment and record maintenance process of one embodiment of the invention.

FIG. 2 Certified patient record of one embodiment of the invention.

FIG. 3 Schematic of information transmittal pathways for the collection and compilation of medical records according to one embodiment of the invention.

FIG. 4 Structure and access points according to one embodiment of the invention.

FIG. 5 A/B: Schematic transmittal pathways with regard to decision support models according to one embodiment of the invention.

FIG. 6 A/B: Schematic transmittal pathways with regard to report requests according to one embodiment of the invention.

FIG. 7 Schematic transmittal pathways with regard to trending alerts and reminders according to one embodiment of the invention.

FIG. 8 Schematic transmittal pathways with regard to the input-vetting and certification process according to one embodiment of the invention.

### DESCRIPTION OF THE INVENTION

As embodied and broadly described herein, the present invention provides methods, apparatus and tools utilizing broadband computer-based networked systems for consumer control and management of medical records. The invention also provides for the creation, storage and access of secure medical record databases and methods for analyzing and securely transmitting the medical records.

To a very large extent, medical records are stored on paper or in other similar tangible means. However, medical records are increasingly being transferred to digital formats and stored electronically, or simply being originally created electronically. The storage space needed for electronic records is much less than for conventional, paper records, and the creation and storage of such records can be inexpensive and efficient. All such electronic medical records are maintained by the physician or more often the institution at which they were created (e.g. hospitals, physician's offices, health plans, insurers, employers). Access to these records is restricted as each institution requires complicated and lengthy procedures for their release. Further, the storage and management systems available at these institutions are controlled and managed by a diversity of software and authorization systems, most if not all of which do not or cannot interact. By having medical information scattered in various institutions, inconsistencies and other anomalies in the information may be created leading to duplicative tests, unwanted or unnecessary procedures and even misdiagnoses. The complication are compounded when considering issues of payment, insurance and employer requirements.

The present invention is directed to an Internet, particularly the World-Wide Web (“WWW”), or other broadband computer-based networked system, operated by a service provider, that enables individuals (e.g. members of the service provider's organization) to assemble, update, enhance, analyze, securely store and transmit, certify, and otherwise manage their own medical records and, under appropriate circumstances, the medical records of their family, friends, clients, or customers. The invention is computer-based in that the medical records are stored and maintained on a computer or similar device. The system is networked meaning that medical records are maintained at one or a few central locations which can be accessed from a plurality of different sites. Further, the exchange of information between the central location and the multiple sites is two-way, meaning that information can come into the system from different sources and can also flow out of the central location to different users. A medical record is a compilation of medical information as recorded by a physician, nurse, health care worker, social worker, insurer or other health professional. As used herein, a medical record is not just medical information pertaining to a patient, but medical information that is recorded by medical professionals for use by those same professionals and/or other medical professionals in rendering treatment to the patient or others, or for use as a basis for payment obligations. Preferably, a medical record comprises that medical information pertaining to a patient who receives a treatment that is traditionally documented by the health care professional and associated caregivers who administered that treatment. Determining what is to be documented and maintained in a medical record is defined by standards which are well known to those skilled in the relevant health care field and by organizations such as, for example, the American Medical Association (“AMA”) and non-U.S. counterparts of the AMA.

According to the invention, all medical record information is maintained in an electronic format in the system (i.e. paperless). Electronic means that the system carries and stores the information in binary form as a series of bits that can be maintained on and transferred between computers. There are no paper or film (i.e. tangible or physical) records that could degrade with time or simply wear out from extensive use. As the information is available at the touch of a keyboard anywhere in the world (e.g. where ever Internet access is available), no individual storage space is required for the patient or the system provider (other than for equipment). More information and easy access to that information allows and actually encourages persons to better analyze their medical records, learn more about their medical treatment history, including possible future considerations, and better negotiate with health care institutions and payors. Members benefit from increased computer access to their own medical records (and those of their family) include, most importantly, better health. As benefits to members from increased computer use accrue, society benefits as well from the efficiencies in the delivery of health care services and increased health of the population. Additional advantages include improved management of health care, an improved ability to obtain detailed information, an option for supplemental analyses of the medical record data from the system provider, and utilization of all such information in better negotiating with health care providers (or others) for care and cost options. Further, the system of the invention does not require the installation of new or even dedicated equipment or hardware. Both potential members (e.g. patients, families, companies) as well as those who would be supplied medical record information from the system will usually already have suitable computers and access to network connections (e.g. Internet, WWW, modem, Ethernet, infrared, optical, cellular or other wireless). Those who may not are likely in the process of obtaining equipment and suitable access because the industry demands it and because the system of the invention does not require dedicated equipment. Further, the invention offers a consumer or hands-free format in which the system provider conducts integration activities such as collection and compilation of medical record information. With a system that operates behind the scenes, individual patient are relieved from having to contact each health care provider themselves to collect the records.

The invention is directed to a computerized patient-based primary medical record system for the management and control of one's own medical records. The system of the invention is surprising because, traditionally, medical records have been considered the property of the health-care provider (e.g. hospital, physician, institution). Healthcare provider systems are not patient centered, but hospital or physician centered because the hospital and/or physician, not the individual patient, both controls and maintains the record. In fact, if certain medical information was not in that specific record, but was needed for further treatment of the patient, that specific hospital or physician would typically perform the necessary testing. This is regardless of whether the same information was available in medical records maintained by another physician or another hospital. Thus patients are forced to undergo needless and costly additional testing. In administering health care, conventional wisdom considered it essential to rely on one's own institution for medical information for both practical and legal reasons. Practical reasons included an unacceptable risk of tampering and a belief that patients were unable to maintain their own records. Legal reasons included malpractice concerns that encouraged first-hand confirmation of all test results. These conventional views impose added expenses to healthcare. More importantly, conventional medical record systems fail for highly mobile populations because medical records become separated (sometimes permanently or irretrievably) from patients who have relocated. With the system of the invention, patients who have moved away from previous healthcare services benefit from not having to rely on contacting those prior physicians which may have moved on themselves. By keeping control of medical records with the patients, and implementing the system of the invention, privacy and liability concerns are in the hands of those individuals most affected, the patients themselves. With the implementation of HIPAA, this becomes even more useful.

The system of the invention is also surprising because it allows medical records to be utilized to their maximum intended potential. Conventional medical records are tools for the healthcare provider with very little use beyond direct care of the patient. Unlike conventional procedures, with the system of the invention, medical records become a commodity with intrinsic value and that value can be fully exploited. For example, medical records according to the invention can be used by the individual patient in setting, measuring or changing life styles, and in choosing insurance coverage and employment benefit options. Choices with regard to nutrition (e.g. based on cholesterol levels), activity (e.g. based on blood pressure), over the counter (“OTC”) medication (e.g. aspirin for heart conditions), and life and health insurance options can be made by patients themselves and would be based on complete and accurate information. Benefits of the system of the invention include a healthier and more informed population that sets it's own healthcare priorities.

The system of the invention is patient-based which means that, unlike institution-based medical records systems (e.g. hospital-based), the medical records of an individual are controlled and managed by that individual (e.g. who may be a member or client of the system provider). Control may be exercised using appropriate search or analytical tools, and secure storage and transmission facilities, all of which may be a part of the system. Also, a surprising aspect is not just that the system is patient-based (i.e. patient-centered), but that the system comprises “primary” records. Primary medical records are the medical records of a patient that can be relied upon by health care professionals and used as a basis for the immediate care and treatment of that patient. This is in direct contrast to other network systems that are commercially available, which specifically state that their system cannot be relied upon for primary care and treatment of a patient.

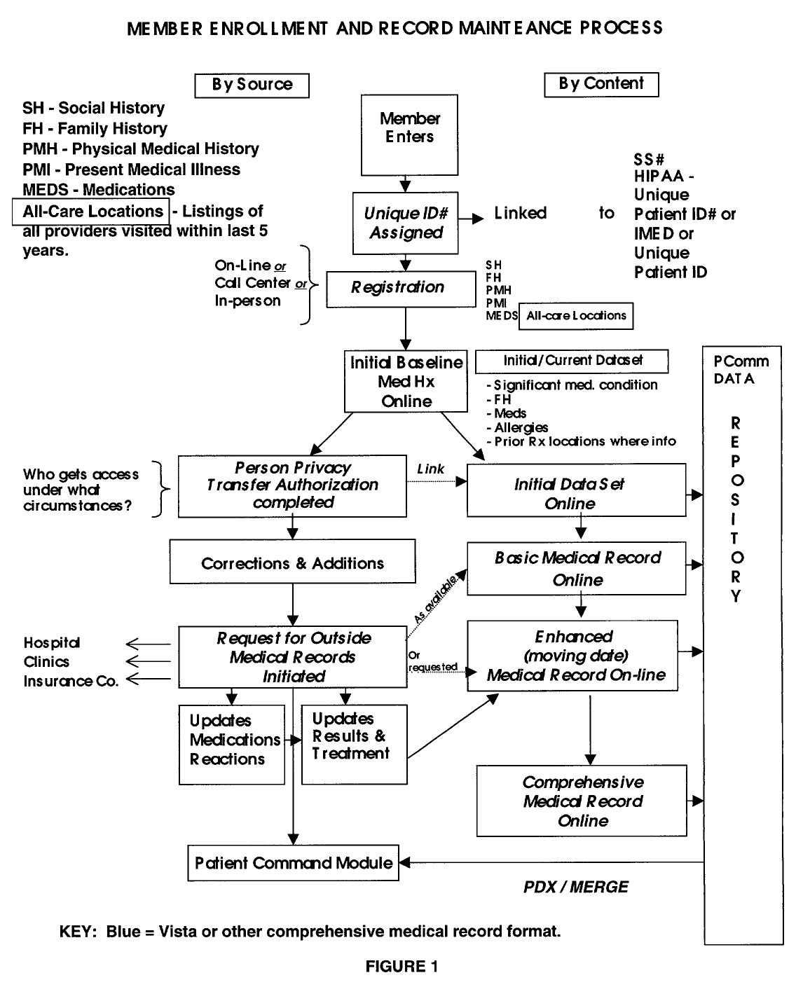

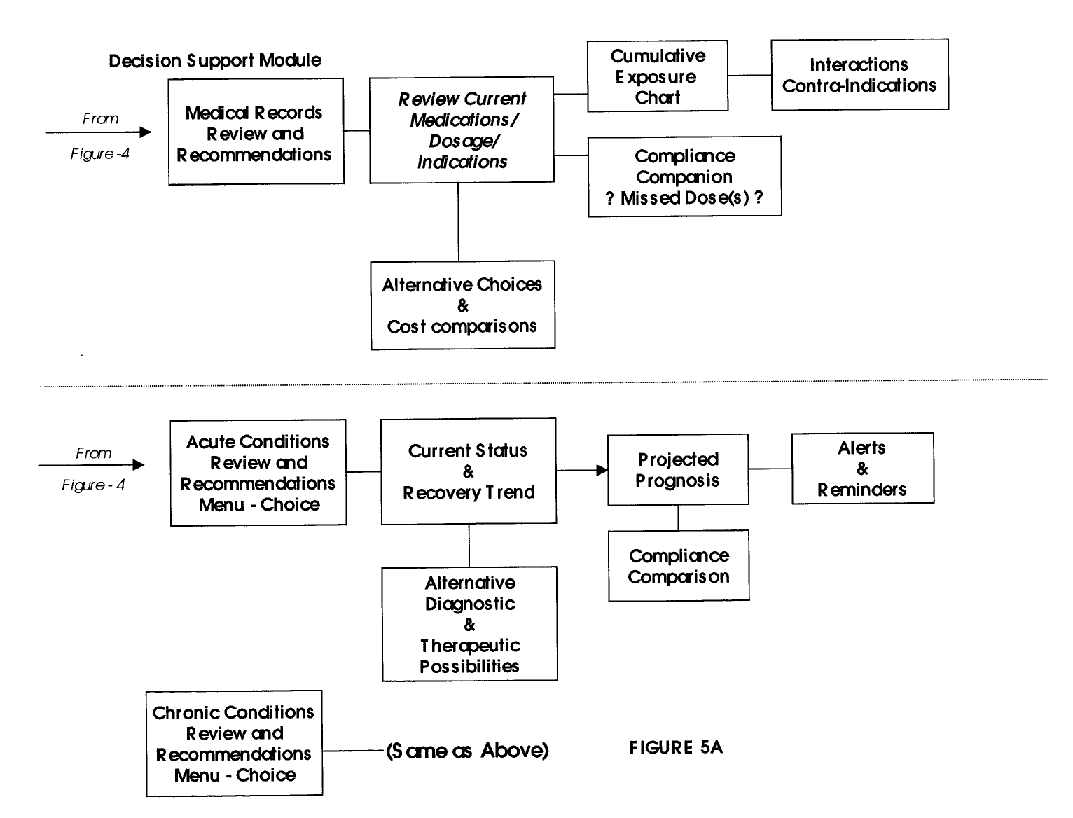

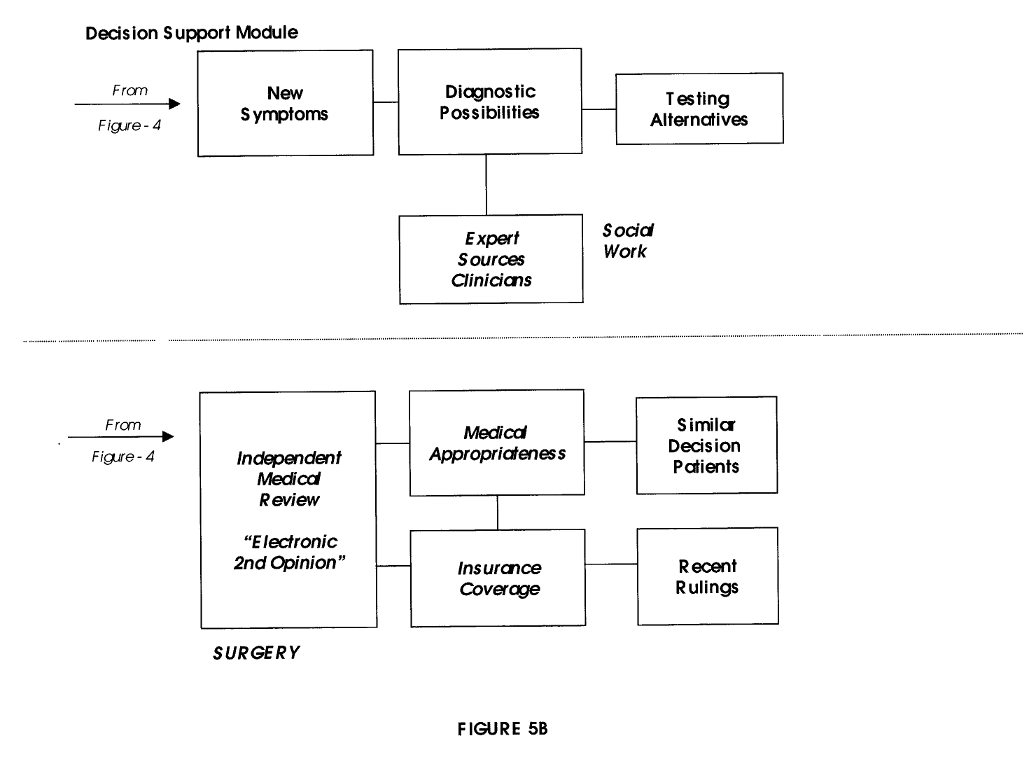

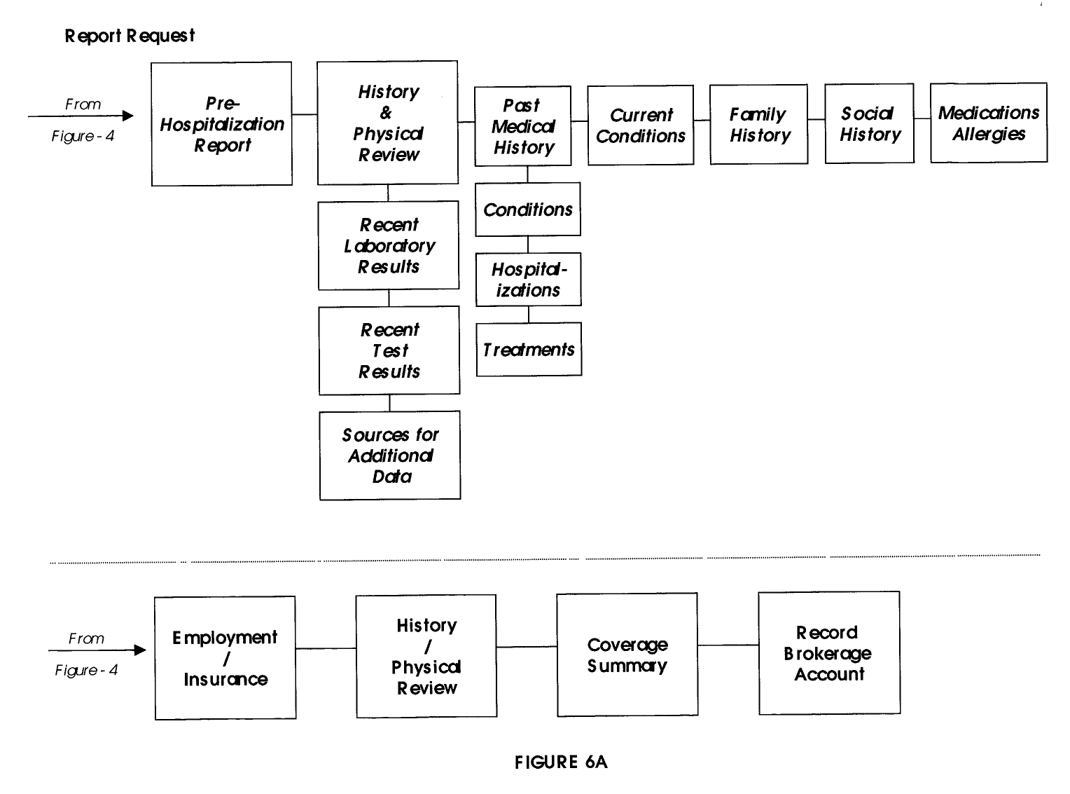

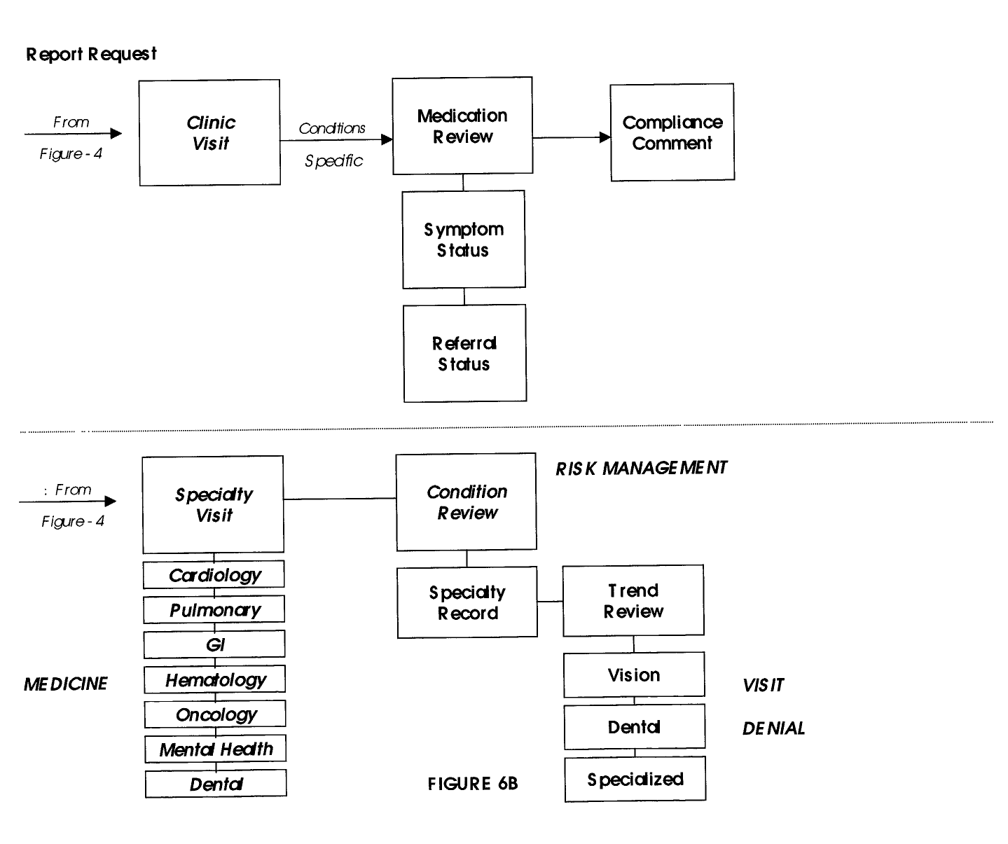

A structure of a preferred embodiment of the invention is depicted in FIG. 1. As shown, each medical record is compiled on a patient by patient basis. The patient enrolls with the system provider and is assigned a specific identifier (e.g. identification number, symbol or icon). Once assigned with an identifier, a patient file, i.e. medical record, can be created. First, basic information pertaining to the patient is entered (e.g. full name, familial history, current and prior addresses, prior and existing significant medical conditions, allergies, etc.). This information may be obtained directly from the patient or directly from a health care professional (e.g. physician) or entity (e.g. hospital). These data as well as all data pertaining to the record is encrypted (partially or fully as desired) to assure personal privacy and compliance with HIPAA or other similar laws and regulations. Corrections such as additions and deletions, if desired, may be requested at this point, but can also be requested and implemented at any time. Specific procedures may be implemented to enable corrections so that the records maintain all desired characteristics. Outside records may be added also with appropriate verification and/or certification standards. Verification does not mean that record accuracy may not be challenged. There may be defined procedures whereby members, users or others may challenge the accuracy of certain information in an effort to have that information expunged, corrected or simply noted as disputed. To maintain accuracy, the system may be fully or partially “read-only” for members and authorized persons. Permission or authorization to add, delete or alter any records of a member's medical database may be obtained in the same manner in which conventional records are similarly changed. As shown in FIG. 4, there can be many access points to the system, all of which can be two way. Those with appropriate authority, typically physicians, nurses, health care social workers or other health-care professionals, add to a record when new information is obtained either directly from the patient or indirectly from a hospital or other health care providers. These same persons are generally those who will be provided access to all or part of a patient's medical record as authorized by the patient.

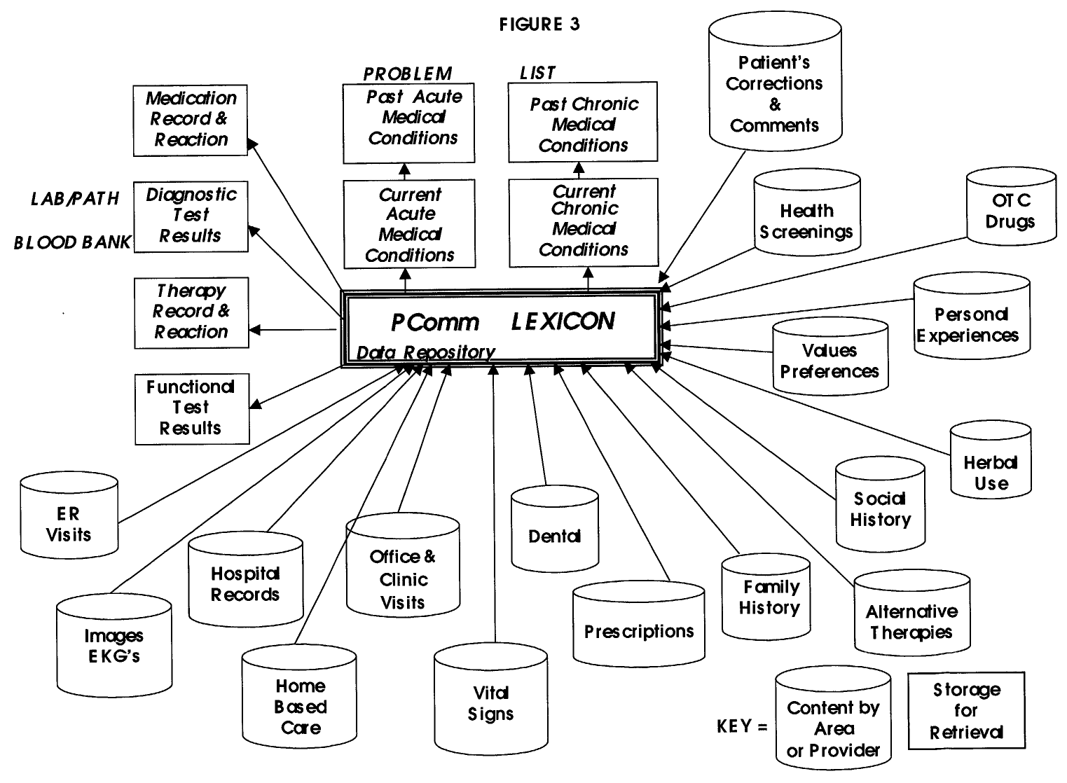

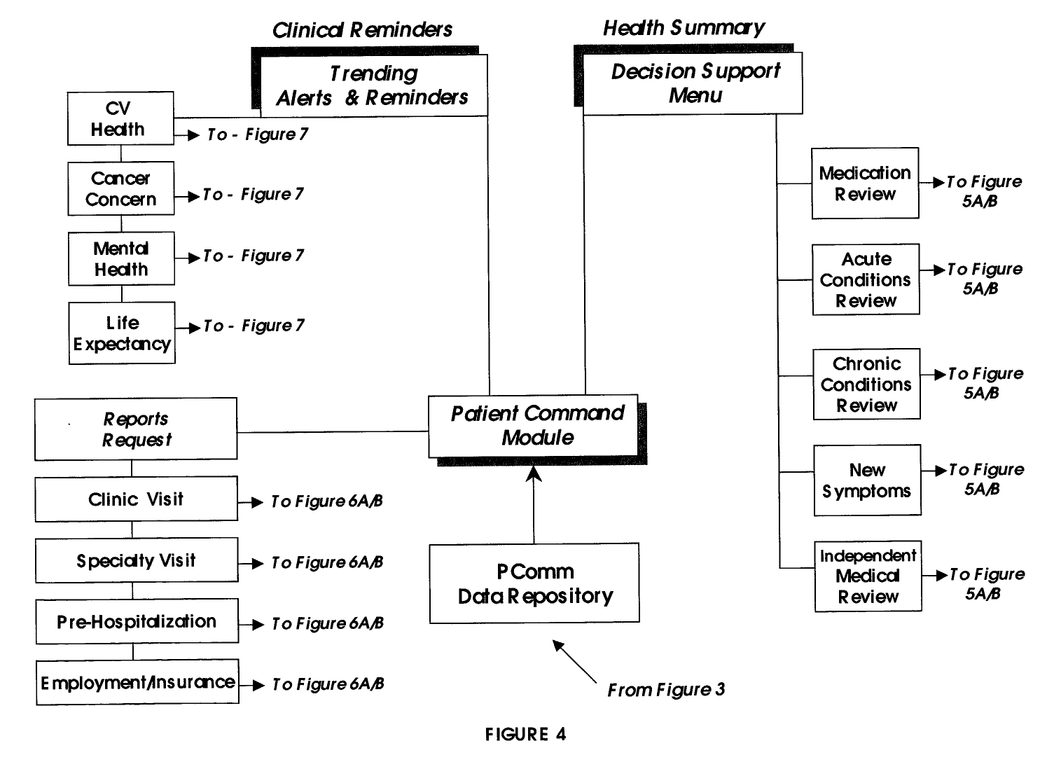

Patients become members by signing up with a system provider which may have certain requirements such as completion of a form which asks for name and other personal information, prior or current medical information, payment of a fee (e.g. for access to a record, for record maintenance, for transmission of a record, for commercial or research analysis of multiple records, etc.), identification of family members and the like. Once signed up, which may require an approval or informational process (e.g. with regard to identification, availability of services or payment), the member provides or directs others to provide existing medical records (in whatever form they exist) to the system provider. The provider inputs those records (generally from a plurality of sources) electronically into the computer system such that the records can be maintained as confidential in accordance with federal, state, local or other rules and regulations (see FIG. 3). In alternative embodiments, the records are inputted directly by the sources themselves.

As the system recognizes no boundaries, it is preferable that the level of confidentiality and security meet or exceed all standards in the geographic area of the service provider. In a preferred embodiment, the level of confidentiality and security for a system of the invention operating in the United States should meet all state standards as well as federal standards such as HIPAA. In such a system, members are authorized to view their own medical records, but may not otherwise alter them (other than having, for example, a member comment page). The system is designed such that the records of any specific member may be transmitted to that member or another party, such as a hospital or physician, as so designated and authorized by that member. Members, who may be provided with a secure access code or other authorization means, request the system provider to supply all or designated parts of their medical record to a third party. This may be for receiving treatment, verifying payment or billing information, or otherwise. The third party receives the medical records and can immediately use that information for the designated purpose (see FIGS. 5A and 5B). Thus, access may automatically trigger input because access to the medical record is being granted for the purpose of administering medical treatment which is in turn then placed into the medical record (see FIGS. 6A and 6B). The result is a basic information module that may be accessed by the patient and those authorized by the patient.

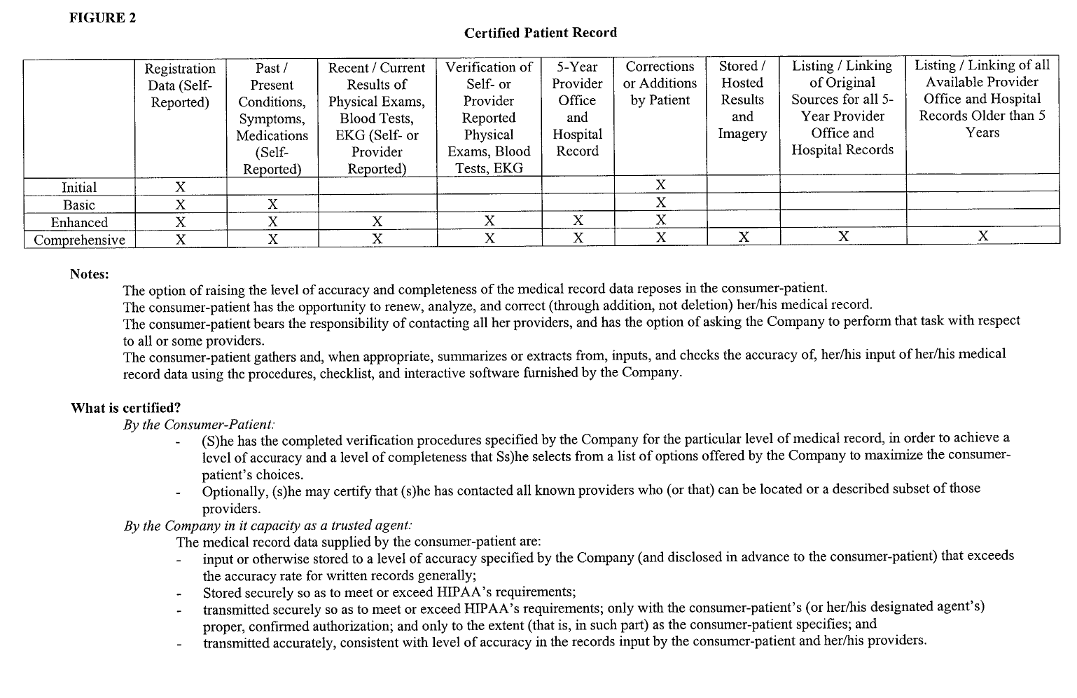

The invention may include a form of medical record that can be completed at one of a plurality of certification levels. In a preferred embodiment, the form of medical record can be completed at four defined levels: initial, basic, enhanced, and comprehensive (FIG. 2). The medical data required is supplied by, or obtained at the direction of, the member, who is a consumer or patient, in satisfaction of a defined record level as specified by the system provider. This enables the member to exercise choice and achieve maximum flexibility as to how much time and effort to expend in accumulating medical data from a variety of sources, that is, from a variety of providers of medical services. The system thus enables the member to take advantage of the rights of access to, and use of, the member's medical records as specified in federal law, including HIPAA, similar state law or other standards or regulations of privacy and security. Certification levels may refer to standards of verification such as, for example, “initial” being self-certification wherein the member certifies that the record is correct, “basic” whereby the system provider certifies that the record is complete for all information gathered, “enhanced” whereby the system provider certifies that the information is complete and correct, or “comprehensive” whereby the system provider certifies that the information provides a complete, accurate and verifiable medical record. Subdivisions of each level such as, for example, grades may also be utilized (e.g. Basic-1, -2, -3, etc.). Alternatively, the certification level may also provide an indication of the level of completeness of the record. For example, an initial level of certification may be limited to annual medical examinations. Data associated with such an examination is input into the system and each input would include an indication of source which may be verified by the system provider according to provider-defined criteria. A basic certification level may include information necessary for a initial certification level, plus additional information relating to hospital out-patient procedures performed along with source and source verification. An enhanced level of certification may include basic information plus further in-patient information. A comprehensive level may include enhanced information plus correlation information such as, for example, a review for completeness, vetting, a review for accuracy, and noting and/or linking of any discrepancies (e.g. drug allergies, disparate diagnoses, anomalies, and otherwise unexplained treatments and observations). Certification may simply state that the record is correct in all material respects or that the record is internally consistent. Errors identified in medical records may be corrected (with appropriate annotation) or simply noted. Suggestions in the form of supplemental computerized evaluations or other helpful comments may be included with comprehensive certification as to possible diagnoses, possible treatment or health options, and the like. Thus, a part of each level of certification may be a verification that the information is exactly as it appears in the paper or other tangible or even electronic file of the original source, or possibly better. As can be seen from FIG. 3, the number of possible sources can be vast. Examples include physician offices (e.g. medication records), blood/path labs (e.g. diagnostic test results), dental offices, psychological profiles, mental aptitude results, hospitals (e.g. records), other medical records (e.g. family histories), pharmacies (e.g. OTC drugs), and even direct input from the patient (e.g. social history). Direct communication pathways can be created between the system provider and all of these entities because the invention does not necessarily require new or even dedicated equipment.

The system also makes available, to each member, computer-based analyses of medical information and related information about possible and available treatment options so that the member is in a substantially improved position to deal with health maintenance organizations, health plans, or other service providers, employers or payors for improved diagnostic and treatment regimens. None of these features are directly available to patients from conventional medical information management systems.

Search and analysis tools may be incorporated by the system to identify specific aspects of a single record such as, for example, all information relating to heart rate, blood, kidney function, neurological effects, the administration of general classes of drugs or a specific drug. Errors may be expunged or simply identified and linked (i.e. a notation placed into the record that the information specified is inconsistent with other information in the record that is also similarly identified). Generally, clear errors and errors in input may be identified and expunged while inconsistencies or other unexplained anomalies may preferably be identified and/or noted and linked.

Medical records generally contain all information relevant to the procedure to which the record pertains (e.g. hospital stay, drug treatment, surgery). The relevance of any specific medical information is determined by the health care professional and/or medical associations such as the American Medical Association. Medical records that are verified as accurate attain the aspect of non-repudiation (i.e. that the accuracy and correctness of the information is as good or better than exists at the source sites from which the records were obtained), and may for all purposes be relied upon. As such, non-repudiated records may therefore be primary for future treatment or diagnoses. This aspect of non-repudiation is believed to be unavailable from any other medical information system. This allows the system provider to guarantee or warranty that the information can be relied upon with regard to future treatments (i.e. are primary records), payment issues and any other considerations.

Another embodiment of the invention is the resulting database of medical records, which includes not only the compiled medical records of a plurality of patients, but one or more of designated certification information, verification information, authorization information, notations for inconsistencies and anomalies, and patient comments. This database, which is patient-centered, can be accessed by any member, but only to the extent that the member to whom the record pertains, the member's agent or another authorized user is able to access only that member's record or selected records (in whole or in part) as authorized. All other patient records are maintained confidential and inaccessible to the designated member. To maintain the electronic wall between each record, each medical record may be input using different cryptographic techniques using passwords, keys, and the like. Alternatively, each medical record may input using common encryption software, but accessible only through unique codes, keys, or varying levels of authorization, that are assigned to each member. These and other input and storage options can be performed using commercially available software, hardware and the like.

The invention includes procedures and mechanisms for the member or other sources to supply information to the database using a variety of secure and insecure means (including, but not limited to, mail, courier, facsimile, and a variety of electronic or optical media and transmissions systems including e-mail) and data formats, and to use a variety of encounter and treatment forms, translation and transcription means which may be offered by the system to facilitate the input of these data and their updating, all according to member preferences. The system also accommodates input and monitoring means to the member in the commercial marketplace from time to time as permitted by technology and regulatory developments. Medical records that can be input include, for example, information in any sort of standardized format (optionally according to pre-determined forms designed by the source or service provider), or non-standardized in most any tangible format. Tangible formats include any electronically formatted information (e.g. CAT scans, MRI images, radioscopic diagnostics, radiographs, or any other type of prognostic, diagnostic or laboratory result), documentary information (e.g. inpatient or outpatient charts, written comments from health care workers), or even figures (e.g. drawings and/or text that can be optically or digitally scanned).

All such information, including information in standardized and non-standardized formats, may be integrated into the database of the invention. Accordingly, another embodiment of the invention is the integration of medical records. Integration is accomplished by obtaining medical information of a patient, which may include medical records, from a plurality of sources, and entering that information electronically into a computer system of the invention. Possible sources include primary sources (e.g. hospitals, physician's offices and clinics that directly administer treatment to the patient), and secondary sources (e.g. diagnostic services performed at laboratories), and also payor sources such as, for example, insurers, health maintenance organizations, preferred provider services and employers. Integration according to the invention creates a completely uniform, cumulative medical record within a single computer system. As such, access to that record is rapid and efficient, and can be automatic or configured to a user's needs as compared to conventional procedures. More importantly, integration among, for example, health care providers, clearinghouses, payors, regulatory authorities and others is not possible with institution-based records because the various institutional sources, to the extent they contain electronic records, are typically created using different software, computers, operating systems and security systems, most and often all of which are incompatible with each other. Further, access rules and policies are often quite different, change without notice, and, more importantly the computer systems are not and cannot be connected so as to integrate effectively or in many cases at all. Even if integratable connections were possible, issues of system optimization, security and confidence would be raised sufficient to prevent useful integration. Using the integrated system of the invention, treatment and payment issues, which are often interrelated, can be resolved quickly and efficiently with a minimum of inconvenience.

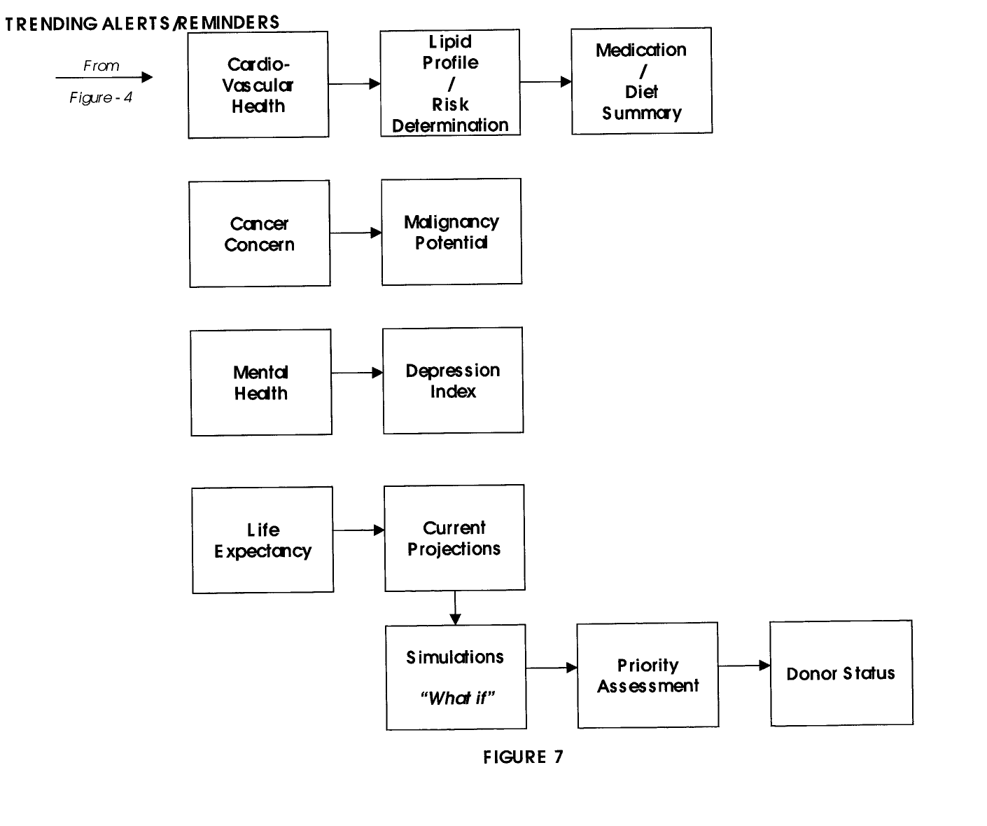

Integration is records-based (e.g. in XML, HTML, or SQL database and the like), not institution-based, and is accomplished by obtaining the information in the format in which the information already exists, whether that be electronic, paper or otherwise (e.g. IDX format). The format is then introduced into the database of the invention using commercially available methods such as, for example, direct input for electronic information and, preferably, scanning for tangible information such as paper records. Integration is also preferably compatible with other institutional systems so that it can be easily transmitted and accessed by authorized parties (e.g. physicians, hospitals). Once input, the now completely electronic information (which is preferably in uniform or universally accessible software codes creating a standard format) can be organized and/or supplemented by the addition of one or more of: a table of contents, an index, a source notation for each specific record, electronic search tools, annotations for input or recording errors with regard to procedures or even treatment (which may be linked for ease of identification), treatment options, health care choices, cost choices, payment choices, verification and the like. The resulting database may be organized according to subject categories including, for example: cardiovascular health, diet concerns, cancer concern, malignancy potential, mental health, current projections, and donor status (FIG. 7), time frames with regard to treatments or age, or in any means desired by a user.

A preferred embodiment of the invention also includes protocols and means for the member to certify the extent to which the verification procedures as specified by the service provider have been completed for the particular certification level of the medical record. Verification levels can be designated to achieve any one of various levels of accuracy and/or levels of completeness that the member selects from a list of options offered by the service provider. Optionally, as an additional element of creating a certified medical record, the member or the service provider may certify that they have contacted all known providers who can be located, or a described subset of those providers, or has otherwise updated the medical record to meet a range of specified standards. A preferred process for inputting information into the system of the invention is shown in FIG. 8. The medical record begins as information that is input from the patient. Further information can be obtained from other sources (medical professionals and paraprofessionals, nurses, physicians), and all of the information subject to review and appraisal by clinically trained experts or record-experienced experts. Medical records that have been so reviewed are considered to have been vetted. Vetted medical records contain corrections and annotation information such as, for example, a review for accuracy and completeness noting and/or linking any errors or discrepancies (e.g. drug allergies, disparate diagnoses, anomalies, and otherwise unexplained treatments and observations). Vetting may be a part of a certification standard (e.g. comprehensive) or may simply be a statement that the record has been vetted and is correct in all material respects, is internally consistent and/or has been corrected. Preferably, vetting is performed by the patient, by the source from which the records were obtained, by the system provider, or by a combination thereof. As such, vetted medical records can be trusted medical record that are primary for the patient.

Medical records, as is their very nature, generally must be maintained as confidential to ensure a desired or federally or state-mandated degree of privacy. As such, security may be critical to inputting, viewing and transmitting medical records. Preferably, the records as well as the means for collecting, inputting and transmitting medical records are encrypted. Input systems exist and are commercially available to encrypt and secure transmission of information among different users. Suitable encryption systems include the public key infrastructure or PKI such as described in A Practical Guide to Public Key Infrastructure, published by Xcert International, Inc. (Copyrighted 1999 by Xert International, Inc., Part No. PG-200040-DT1000, and which is entirely incorporated by reference). Other systems include random number and pseudo-random number encryption, secure socket layer, https, biometrics, digital signatures, digital certificates, hash functions, time stamping, symmetric encryption whereby the sender and the recipient have a common key, and asymmetric encryption whereby trap-door equations are used to create two, long, related numbers. Asymmetric encryption tools generally involve implementation of a public key which is generally easily and readily accessible, and a private key which is kept secure. Certification authorities are commercially available which can rapidly and easily confirm public key identity (e.g. www.verisign.com; www.cybertrust.com; www.cylink.com; www.xcert.com). Further, systems are available or can be designed by those of ordinary skill in the art with varying degrees of complexity to offer multiple levels of encryption as desired.

With secure input and access systems and integrated records, it is therefore possible to have an information system that creates records with the attribution of non-repudiation, i.e., a system acknowledged as authorized to a personal, federal, system, state or other standard of privacy and security. Non-repudiation of medical records, according to the invention, provides a level of assurance to the correctness and accuracy of records. It is not simply that non-repudiated records are correct, but that they are reflective of what was created by the physician, health care worker or hospital as input by those sources or by the patient consumer. The non-repudiation of a record from a document provider or payor source creates efficiency and practical effectiveness.

The member may also use these data to manage participation in regional, national, or international donor networks (e.g. organs, cornea), either as a potential recipient or as a potential donor. The member may also use the system to barter, sell, or otherwise market or use their medical record data, identified or de-identified in whole or in part, to gain additional health care or for other purposes. The service provider of the system can use the system to broker the member's medical record information or direct all or portions of those records to physicians and other health-care workers, laboratories, research centers, government agencies and health care organizations, all at the patient's discretion and direction.

The invention enables the service provider in its capacity as a trusted agent to certify that the medical record data supplied by the member are: (i) input or otherwise stored to a level of accuracy specified by the service provider (and disclosed in advance to the member) that meets or exceeds the accuracy rate for paper-based medical records; (ii) securely stored so as to meet or exceed HIPAA's requirements; (iii) transmitted securely so as to meet or exceed HIPAA's requirements, only with the authorization of the member (or their designated agent), confirmed authorization, and only to the extent (that is, in such part) as the member specifies; and (iv) transmitted accurately, consistent with the level of accuracy in the records input by the member and/or the member's providers (see FIG. 2). The invention further provides an electronic system whereby members of the provider system network may request corrections to medical records directly to the source of that record. For example, HIPAA introduced suggested procedures for patients to suggest amendments, propose corrections, dispute entries and make other comments directly to the source of the medical record. Navigating HIPAA's suggested procedures may be an optional part of the invention. Procedures may also be established for responding to requests for authorization to release medical records, financial information verification or dispute verification, or simply to provide notice of government or other investigation into one's medical records (see FIGS. 4-6). Requests and notices may be transmitted to the patient member with appropriate response or other action options.

Further, the invention makes available to the member certain analytical tools of varying complexity, sophistication, and cost to enable the member to obtain various supplementary computerized categorizations, analyses, and option lists with respect to medical conditions disclosed or described in, or inferred from, the medical record data for that member that are stored in the system. Analytical tools are commercially available and may be acquired or licensed, or developed by the system's provider. Further, the system makes available to the member financial analytical tools of varying complexity, sophistication, and cost to enable the member to obtain and assess competing cost options for various courses of treatment. The system further enables the member to transmit securely all or some defined subsets of medical record data to a variety of providers for purposes of obtaining or facilitating medical treatment or for other purposes, such as dealing with insurance or other payment issues, or for a variety of purposes relating to health care operations such as may be defined by and under HIPAA or other federal laws or complementary state statutes or regulations.

Similarly, the invention enables the member to update their individual medical record by obtaining additional medical record data, either directly from a provider (so that the member then arranges for its input into the system), or by enabling the provider to transmit the data by using a variety of secure and insecure means (including, but not limited to, mail, courier, facsimile, and a variety of electronic or optical media and transmissions systems), and to use a variety of medical monitoring devices available for use at home or for use in a health care provider's facilities as well as translation and transcription means offered by the system to facilitate the input of these data, all according to the member's direction and preferences.

Ancillary features of the invention may include lists of symptoms and diseases, classifications of diseases, glossaries of medical and health care regulatory terminology, directories of health care providers, news regarding recent developments, and links to other sites containing related information that the member may find helpful in using the system. Further, the system may contain health information particularly tailored to the member's needs as determined by age, sex, specified medical condition, disease or disorder, by specific request, or otherwise.

The invention in any of these embodiments includes creating a primary medical record because, in part, medical record data is securely compiled, stored, and accessible in one place for transmission at the direction of the member or others appropriately designated. The medical record is primary in that the consumer can rely on these compiled data as the primary resource about their general health or particular medical condition. In addition, these data can be used as the primary resource for a variety of health care providers and/or payors who furnish health care or advice about health care to the individual or payment or payment claim processing to the patient or the patient's providers. This facilitates examination of member records as necessary, appropriate, or otherwise useful to examine medical record data, and analyses of data created by other providers.

Further, the invention allows the system provider to de-identify and aggregate medical record data so as to enable the system provider to compile ever-larger databases of aggregated medical data. These data can then be used as part of a variety of analytical tools and processes that the system provider can use to improve the system's analytical tools used by individuals as well as to create for the system provider information products, such as databases and a variety of analyses using these databases in whole or in part, that can be marketed to a variety of people or entities for a variety of purposes. In a preferred embodiment, identified data, or a particular patient's data, whether or not de-identified, would be included only with the patient's explicit prior authorization.

Another embodiment of the invention is directed to the database created from the input of individual medical information. By screening out identification criteria (such as names, contact information, and other such features), that wealth can be mined by third party medical investigators (or novice individuals) to explore, for example, the incidence of certain diseases or conditions, or to generally follow the health of individuals, the population as a whole or a subset of the population. Correlations between health care and, for example, smoking, exercise, age, diet, sex, child bearing, prenatal care, prior diseases or conditions, and nutrition can be securely tracked without compromising privacy or security of the system. These correlations and also general and specific trends in health can be analyzed for populations and/or individuals by both investigators and other individuals as desired. Individual health alerts and reminders can be posted to a general site, accessible to all or a plurality of persons, or to specific accounts within a member's medical record according to predetermined and agreed to criteria.

A preferred embodiment of the invention includes a Medical Information Social Worker Interface (“MISWI”). The MISWI is designed specifically to allow appropriately trained social workers to assist socially or economically disadvantaged people who need or desire to compile their medical records, analyze those records, learn more about their medical condition, and negotiate with the health care system for treatment and cost options. The MISWI allows a medical information social worker to assist clients in finding medical record information, inputting it into the system, updating it as necessary over time, certifying it to the appropriate level as described elsewhere in this application, and then using it to obtain health care services and identify and select various cost options. The MISWI z; n offers a cost-effective means for governmental and non-governmental service agencies to increase the quality of health care available to their clients who are economically and socially disadvantaged, and who do not have access to computer technology on a routine basis, or who may lack the skills to take advantage of that technology.

The MISWI offers wide use because it provides governmental and non-governmental service agencies a means to make more comprehensive, accurate medical record data available to a wide variety of health care providers and payors for disadvantaged populations. These providers include hospital emergency rooms, clinics, and other facilities that routinely see patients who suffer from a variety of ailments, who are not computer-literate, who may be homeless, and who, when seeking medical treatment or other care, do not bring with them adequate medical records (and often no medical records). The MISWI embodies the same privacy protections and security features as the invention generally. At the same time, the MISWI is designed to allow the medical information social worker to work with clients on a privileged or confidential basis (according to applicable law) to assist clients who cannot, or are disinclined to attempt to, use the system without the social worker's assistance. The consequence is that federal, state, and local governmental and/or private health agencies are able through the MISWI to use the system to assist clients in managing their own health care. This is a cost-effective way of extending essential health care services, and it is therefore a significant bridge across the digital divide.

Other embodiments and uses of the invention will be apparent to those skilled in the art from consideration of the specification and practice of the invention disclosed herein. All references cited herein, including all U.S. and foreign patents and patent applications such as U.S. Provisional No. 60/216,147 and HIPAA including all associated implementation statutes and regulations, are specifically and entirely hereby incorporated herein by reference. It is intended that the specification and examples be considered exemplary only.

1. A broad-band, computer-based networked system comprising:
an encrypted collection of electronic medical records of a plurality of persons wherein:
the medical records are obtained and electronically compiled from a plurality of sources;
the medical record of a person is transmissible in whole or in part only to that person and others authorized by that person;
each medical record can be supplemented with additional information; and
additional medical records for additional persons may be added to the collection;
a secure access for allowing each person to access only their own medical record; and another secure access for allowing said others authorized to access only that person's medical records.

2. The system of claim 1 wherein said medical records are electronically complied by direct input or digital scanning of written information into a computer-readable format.

3. The system of claim 1 wherein the sources are selected from the group consisting of hospitals, clinics, physician's offices, pharmacies and combinations thereof.

4. The system of claim 1 wherein said medical records are transmissible through the Internet.

5. The system of claim 1 wherein the medical record for each person contains one or more of: a table of contents an index, a source notation for information contained within the medical record, an electronic search tool, annotations for errors, linked annotations for errors, treatment options, health care choices, verification standards and news items relevant to the information in the medical record.

6. The system of claim 1 wherein the secure access and the another secure access comprise passwords or encryption keys.

7. The system of claim 1 wherein the others authorized are selected from the group consisting of physicians, nurses, hospitals and health care institutions.

8. The system of claim 1 wherein one or more medical record possesses the characteristic of non-repudiation.

9. The system of claim 8 wherein said non-repudiated medical record is primary for treatment of the patient to whom said non-repudiated medical record pertains.

10. The system of claim 1 wherein each medical record is certified as accurate.

11. The system of claim 10 wherein each certified medical record is certified as accurate by the patient, by the source from which said each medical record was obtained, by a system provider or by a combination thereof.

12. The system of claim 1 wherein the collection comprises medical records of more than 100,000 persons.

13. The system of claim 1 wherein said collection complies with a federal or state standard of privacy and security.

14. The system of claim 13 wherein the federal standard is the Health Insurance Portability and Accountability Act of 1996.

15. The system of claim 13 wherein said collection complies with all state standards of privacy and security for the geographical area in which the system operates.

16. The system of claim 1 further comprising a fee which is assessed for each access to a medical record.

17. The system of claim 1 further comprising a fee which is assessed for maintenance of a medical record.

18. The system of claim 1 wherein each medical record is vetted.

19. The system of claim 18 wherein the vetted medical record contains one or more of: corrections of incorrect information, notations of incorrect information, notations of anomalies, linking of errors, linking of anomalies, notation of discrepancies, linking of discrepancies, and combinations thereof.

20. A broad-band, computer-based networked system for individual control and management of electronic medical records comprising a plurality of medical records representing a plurality of persons that complies with a federal standard of privacy and security.

21. The system of claim 20 which allows for certification of said medical records.

22. The system of claim 21 wherein certification represents a predetermined degree of completeness, accuracy or both to said medical records.

23. The system of claim 20 which allows for vetting of said medical records.

24. The system of claim 23 wherein vetted medical records have been reviewed and corrected or annotated for errors, discrepancies and anomalies.

25. The system of claim 20 which allows for non-repudiation of said medical records.

26. The system of claim 25 wherein non-repudiated medical records are primary for treatment of the person to whom each medical record pertains.

27. The system of claim 20 wherein the federal standard is the Health Insurance Portability and Accountability Act of 1996.

28. The system of claim 20 which further complies with a state standard of privacy and security.

29. The system of claim 20 wherein access to any one medical record is restricted to the person to whom said one medical record pertains or to others designated and authorized by said person.

30. A method for creating an accessible electronic medical records database comprising:
obtaining and compiling a medical record pertaining to a patient;
electronically inputting said medical record obtained into a secure computer database containing other medical records; and
allowing said patient and those authorized by said patient access to said patient's medical record wherein access to all other medical records is blocked.

31. The method of claim 30 wherein the medical record is obtained from a plurality of sources.

32. The method of claim 30 wherein access to the electronic medical record database complies with a federal standard of privacy and security.

33. The method of claim 30 wherein the federal standard is the Health Insurance Portability and Accountability Act of 1996.

34. The method of claim 30 further comprising updating the medical record database with additional medical information pertaining to said patient.

35. The method of claim 30 further comprising securely transmitting all or part of said patient's medical record to a third party as designated by said patient.

36. The method of claim 30 further comprising displaying said medical record pertaining to a patient.

37. An electronic database of medical records created and compiled according to the method of claim 30.

38. The database of claim 37 which contains the entire medical history of at least one person.

39. The database of claim 37 wherein each medical record is remotely accessible in whole or in part only by the patient to whom the medical record pertains and those authorized by said patient.

40. A business model comprising a secure database of medical records obtained from a plurality of sources whereby each medical record is accessible through transmission pathways and only by the person to whom the medical record pertains and those authorized by said person.

41. A method for integrating medical records to create a certified medical record database comprising:
obtaining medical information from one or more healthcare sources for a plurality of patients;
electronically inputting all of the medical information obtained into a secure computer database to create medical records; and
certifying that each of said medical records meet one of a plurality of certification standards established by the service provider to create the certified medical record database.

42. The method of claim 41 wherein any one of the certified medical records can be transmitted only to the patient to whom the record pertains or those authorized by said patient.

43. The method of claim 41 wherein the plurality of certification standards are selected from the group consisting of self-certification, certification by the service provider and combinations thereof.

44. The method of claim 41 further comprising a step whereby said patient obtains an analysis of the medical record.

45. The method of claim 41 further comprising providing said certified medical record database with the characteristic of non-repudiation.

46. A computer system for management of medical records comprising
a database of medical records pertaining to one or more subjects;
receiving means for receiving information pertaining to said medical records from one or more senders;
transmission means for transmitting a portion of said medical records to one or more receivers; and
authorization means for authorizing said senders and receivers according to a set of rules, wherein said set of rules is designated by said subjects.

47. The computer system of claim 46 wherein said database is a secure database.

48. The computer system of claim 47 wherein said secure database complies with a federal standard of privacy and security.

49. The computer system of claim 48 wherein the federal standard is the Health Insurance Portability and Accountability Act of 1996.

50. The computer system of claim 48 which further complies with a state standard of privacy and security.

51. The computer system of claim 46 wherein said receiving means is selected from the group consisting of: modem, cellular receiver, infrared receiver, Ethernet card, facsimile, cable modem, satellite receiver, optical, analog receiver, Internet hub, and web-server.

52. The computer system of claim 46 wherein said transmission means is selected from the group consisting of: modem, cellular transmitter, infrared transmitter, Ethernet card, facsimile, cable modem, satellite transmitter, analog transmitter, Internet hub, and web-server.

53. The computer system of claim 46 wherein said authorization means comprises public key encryption, digital signatures, biometrics, certificate authorities, or user passwords.

54. The computer system of claim 46 wherein said portion of said medical records have the characteristic of non-repudiation.

55. The computer system of claim 54 wherein said non-repudiated medical records are primary for treatment of said subjects.

56. The computer system of claim 46 further comprising an integration means for reception, display, analysis and modification of said medical records available to be performed on a plurality of systems of various health care providers, payors, clearinghouses, oversight agencies and other users.

57. The computer system of claim 46 wherein said database is administered by a service provider other than said subjects, senders, and receivers.

58. The computer system of claim 46 further including vetting means, wherein said vetting means allows said subjects to supplement said medical records with information relating to the accuracy of said medical records.

59. The computer system of claim 46 wherein said medical records are owned by said subjects.
